(19) United States
(12) Patent Application Publication
(10) Pub. No.: US 2023/0194647 A1
(43) Pub. Date: Jun. 22, 2023

(54) CONDITIONAL MEASUREMENT REPORTING MODE FOR POSITIONING

(71) Applicant: Nokia Technologies Oy, Espoo (FI)

(72) Inventors: Ping-Heng KUO, London (GB); Philippe SEHIER, Saint Germain en Laye (FR); Diomidis MICHALOPOULOS, Munich (DE)

(21) Appl. No.: 17/907,021

(22) PCT Filed: Mar. 25, 2021
(86) PCT No.: PCT/EP2021/057658

§ 371 Date: Sep. 22, 2022

Related U.S. Application Data
(60) Provisional application No. 63/004,005, filed on Apr. 2, 2020.

(51) Int. Cl. G01S 5/00; H04W 24/10

(52) U.S. Cl. CPC G01S 5/0063; H04W 24/10; G01S 5/0218

(57) ABSTRACT

Apparatuses and methods are disclosed. A method comprising: receiving (702) one or more criteria, from a location server, related to one or more properties of at least one measurement used for position estimation; receiving (704) a measurement request to perform the at least one measurement; performing (706) the at least one measurement based on the measurement request; determining (708) whether the at least one measurement satisfies the one or more criteria; and determining (710) a measurement reporting mode based on whether the at least one measurement satisfies the one or more criteria in the absence of the location server specifying a measurement reporting mode.

### TECHNICAL FIELD

The examples and non-limiting embodiments relate generally to communications and, more particularly, to a conditional measurement reporting mode for positioning.

### BACKGROUND

It is known to implement tracking using a global positioning system.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting system in which the example embodiments may be practiced.

FIG. 2 is an example diagram depicting signaling associated with positioning measurement criteria, where (*) indicates UL positioning and (**) indicates DL positioning.

FIG. 3 is a logic diagram of a UE/gNB in a first embodiment, based on the examples described herein.

FIG. 4 is a logic diagram of a UE/gNB in a second embodiment, based on the examples described herein.

FIG. 5 shows a functional block that can be implemented at the LMF to determine the criteria that should be transferred to a UE/gNB based on accuracy/integrity requirements.

FIG. 6 is an example apparatus, which may be implemented in hardware, configured to implement a conditional measurement reporting mode for positioning, based on the examples described herein.

FIG. 7 is an example method to implement a conditional measurement reporting mode for positioning.

FIG. 8 is an example method to implement a conditional measurement reporting mode for positioning.

FIG. 9 is another example method to implement a conditional measurement reporting mode for positioning.

### DETAILED DESCRIPTION OF EXAMPLE EMBODIMENTS

The following acronyms and abbreviations that may be found in the specification and/or the drawing figures are defined as follows:
3GPP third generation partnership project
5G fifth generation
5GC 5G core network
AMF access and mobility [management] function
CU Centralized Unit or central unit
DC dual connectivity
DL downlink
DU distributed unit
DSP digital signal processor
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in ENDC
E-UTRA evolved universal terrestrial radio access, i.e., the LTE radio access technology
F1 functional split interface in 3GPP between the CU and the DU
gNB (or gNodeB) base station for 5G/NR, i.e., a node providing NR user plane and control plane protocol terminations towards the UE, and connected via the NG interface to the 5GC; or 5G Node B
GNSS Global Navigation Satellite System
GPS Global Positioning System
I/F interface
I/O input and output
IoT Internet of Things
KPI key performance indicator
LMC Location Management Component
LMF Location Management Function
LoS Line of Sight
LPP LTE Positioning Protocol
LTE long term evolution
MAC medium access control
MME mobility management entity
ng or NG new generation
ng-eNB or NG-eNB new generation eNB
NG-RAN new generation radio access network
NLOS Non Line of Sight
NR or NR- new radio
NRPPa NR Positioning Protocol annex
N/W or NW network
PDA personal digital assistant
PDCP packet data convergence protocol
PHY physical layer
PRS Positioning Reference Signal
RAN radio access network
RAT Radio Access Technology
Rel- release
RLC radio link control
RP 3GPP RAN
RRC Radio Resource Control
RRH remote radio head
RSRP Reference Signal Receive Power
RSRQ Reference Signal Received Quality
RSTD reference signal time difference
RU radio unit
Rx receiver
SDAP service data adaptation protocol
SGW serving gateway
SMF session management function
SRS Sound Reference Signal
TDoA time difference of arrival
TRP Transmission and Reception point
TS technical specification
Tx transmitter
UE User Equipment (e.g., a wireless, typically mobile device)
UL uplink
UPF user plane function

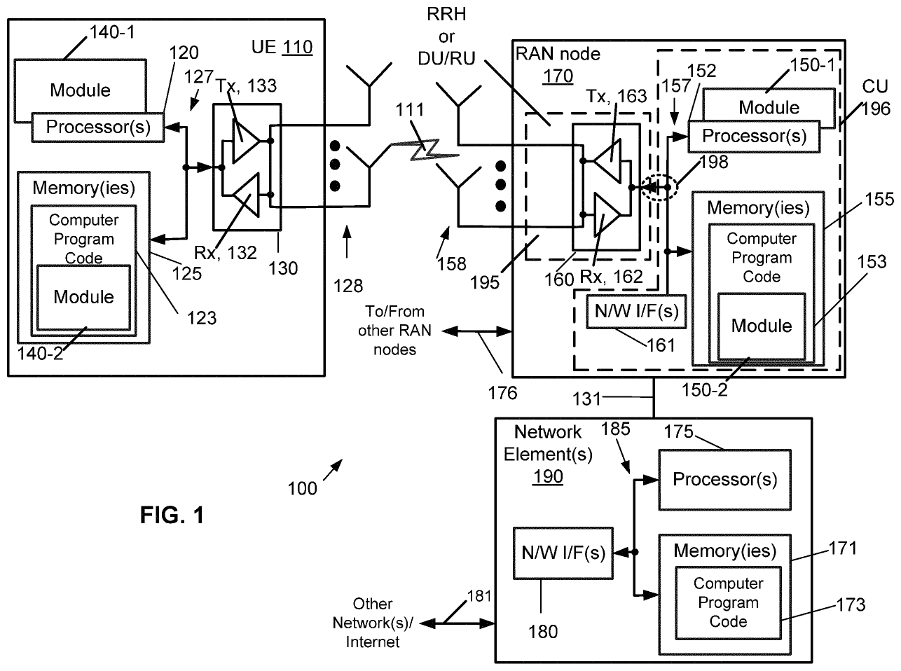

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. The one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNBCU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNBDU is a logical node hosting RLC, MAC and PHY layers of the gNB or en-gNB, and its operation is partly controlled by gNB-CU. One gNB-CU supports one or multiple cells. One cell is supported by one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. The one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, at least one cell covering one-third of a 360 degree area so that the single base station's coverage area covers an approximate oval or circle. Furthermore, at least one cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

The examples described herein may relate to NR positioning. The examples described herein may be used for situations where the position of a device is needed.

Positioning is an enabler for various verticals and use cases that 5G aims to support. By obtaining the knowledge relating to an approximate or precise position of the devices, applications such as location-based services, autonomous driving, and industrial IoT can be fulfilled by 5G systems. Although accurate positioning typically could be fulfilled by GNSS techniques such as GPS, they may not be able to provide positioning with sufficient accuracy in the context of some indoor scenarios, such as factory automation or warehouse management. Thus, RAT-dependent positioning methods based on downlink/uplink signals developed by 3GPP standards (e.g. PRS/SRS) have been extensively studied in LTE/NR.

In the context of RAT-dependent positioning, typically a location server (e.g. LMF) or component (e.g. LMC) deployed in the core network or RAN is responsible for requesting and collecting measurements of PRS/SRS obtained by the UE/gNB (depending on whether a DL or UL positioning method is used). Based on the collected measurements, position of the targeted device can be estimated by the location server using certain algorithms. Obviously, the accuracy of estimation hinges on the quality of measurements reported by the UEs/gNBs. Apart from the accuracy, 3GPP targets to further examine the “integrity” of positioning, which can basically be defined as the trustworthiness of the estimation results.

One prospective definition of integrity can be: The probability such that the resultant positioning error is smaller than a pre-defined level. Thus, to increase such probability, it is useful to ensure that the measurements collected by the location server are in some instances acquired under favorable channel conditions for positioning. This, however, may not be guaranteed by the location server as explained herein.

In the existing RAT-dependent positioning framework, the location server (e.g. LMF) makes a request to a selected set of nodes and instructs the selected node (the selected nodes may include gNB/TRP/UE) to report their measurements on certain SRS/PRS configurations. Depending on the positioning method, the measurements to be reported may comprise RSRP/RSRQ and/or observation timing etc.

Optionally, the location server could further instruct the UE/gNB to report measurements relating to additional propagation paths. Richer contents of measurement results allow more accurate estimation at the location server. For instance, by reporting multiple paths, the location server may be able to identify and exclude certain unfavorable measurements (e.g. NLOS) to achieve better positioning accuracy. However, the values of additional information in the reporting comes at a high cost of heavy signaling overhead in e.g. LPP/NRPPa interfaces. This issue could get worse when multi-beam operation is considered, where a UE, for example, may need to measure and report paths associating to multiple beams from at least one of the multiple gNBs. Moreover, the resultant signaling overhead caused by enriched feedback (e.g. additional paths) does not in some instances translate to benefits—because the reported measurements may not be used by the location server eventually (e.g. if the measurements were obtained under very unfavorable propagation environments without any LoS). This may result in resource (radio, power, battery) wastage.

In consideration of these factors and issues, in practice the location server typically does not request the UE/gNB to report too much details in their measurements. But by doing this, the knowledge of radio propagation conditions at the location server may be very limited, which may mislead the location server such that improper measurements may be included in position estimation, and eventually result in degradation of integrity.

In short, when using the collected measurements for position estimation, the location server may “filter out” some inappropriate measurements that may lead to large errors (e.g. measurements obtained in NLOS propagation environments), but in practice it could be a challenging task for the location server to identify if a measurement is sufficiently appropriate for location estimation due to its limited knowledge of the propagation environment. Note that “measurement selection” is an implementation issue of the location server. Consequently, the location server may not be able to guarantee that the integrity of positioning used by the consumer (e.g. application) can be achieved.

The problem is identified as (and which the examples described herein provide solutions for): The location server may not be able to assess whether the reported measurements are suitable for position estimation due to limited information, while increasing measurement contents on the other hand may lead to heavy signaling overhead that may be prohibited in practice. Eventually, integrity cannot be achieved or accuracy is compromised due to errors resulting from misuse of inappropriate measurements at the location server.

The methods described herein assume that, based on the positioning integrity requirement of the application, or accuracy requirements, the location server is able to identify the conditions that make a measurement “eligible” for sufficient accurate and reliable position estimation (e.g. measurements with strong LoS path). Then, the location server may provide information relating to such conditions to UE/gNBs as the criteria, and so UE/gNB could use the provided criteria to determine if they should (and in how much detail) report the measurements to the location server.

To generalize, the method and associated examples herein comprise the following embodiments, namely Embodiment 1 and Embodiment 2.

In a first embodiment (Embodiment 1), a positioning framework is provided, wherein the amount of measurement information (alternatively, determination or selection of a measurement reporting mode) to be reported by a UE/gNB can be determined by the UE/gNB itself based on certain criteria pre-configured by the location server.

The measurement reporting mode to be selected by UE/gNB (based on if its measurement(s) satisfy the criteria) can be one of the following:

None (no reporting)
Measurements relating to one path
Measurements relating to multiple paths (e.g. strongest N paths, or shortest of N paths)
Full delay-profiles (measurements relating to some paths, wherein a number of paths that are measured/reported may depend on UE capability)
etc.

The criteria can be set by the location server based on an integrity/accuracy requirement (this is an implementation issue), and examples of criteria may include:
Presence of LoS
Strength associating to the LoS (if any)
Number of measured paths
an observed path delay or a delay spread, e.g. whether the observed delay spread exceeds a certain threshold
UE/gNB capability
Any evidence suggesting that the quality of the measurement is questionable (e.g. noise peak, interference, authentication issues of the base stations etc.)
etc.

The criteria provided by the location server, as well as and their corresponding measurement reporting mode, may vary depending on the positioning method to be applied.

In a second embodiment (Embodiment 2), the location server still mandates the measurement type and information that UE/gNB should report, so the UE/gNB does not select the reporting mode by itself as in Embodiment 1. However, the location server still provides preconfigured criteria, and the UE/gNB should include an indication (e.g. 1 bit) in at least one of their reports to indicate whether the reported measurement was obtained under a condition satisfying the criteria provided by the location server.

In an example with the simplest form, the UE/gNB does not report anything (or simply reports an indication) if its measurement does not meet the conditions pre-configured by the location server. The condition may be, for example, the measurement was obtained under a channel with presence of sufficiently strong LoS. Otherwise, it reports the information that has been requested by the location server.

The gain mechanism of the described concept is attributed to the fact that the UE/gNB has better knowledge or capability than the location server to identify certain impairments that may result in unusable measurements. For instance, integrity loss corresponds to positioning errors in the range of kilometers caused by other kinds of phenomenon (noise peaks, interference, fake base stations etc.). In many cases, the UE/gNB has means to detect suspicious measurements in order to discard them (e.g. by time filtering), rather than reporting them to the location server.

A detailed description of the method is as follows. The measurement criteria are transferred to the UE/gNB from the location server. For the case of UL positioning (where gNBs measure and report), the measurement criteria are transferred to the serving gNB and neighbor gNBs via NRPPa, as part of the NG-RAN procedures. For the case of DL positioning (where the UE measures and reports), the measurement criteria are transferred to the UE via LPP, as part of the assistance data signaling.

The UE/gNB receiving the measurement criteria performs measurements, and independently evaluates whether a measurement is accepted or discarded based on the received criteria—equivalently, whether a measurement satisfies the received criteria. Depending on the received configuration on the amount of measurements to be reported (i.e. the measurement reporting mode), the UE reports for the case of DL positioning, and the serving and neighbor gNBs report for the case of UL positioning.

The first embodiment (Embodiment 1) determine(s) the measurement reporting mode based on whether the measurements satisfy the criteria received from the LMF. For instance, the UE/gNBs report(s) some of the measurements satisfying the criteria (instead of reporting some requested measurements as in existing standards) either as standalone measurement (e.g., RSRP measurements) or in combination with measurements from other transmission points (in the case of DL TDoA, for instance) as part of RSTD measurements.

The second embodiment (Embodiment 2) reports the requested measurements and indicate(s) whether reported measurement was obtained under a condition satisfying the criteria provided by the location server.

The measurement criteria are specific to the positioning method used. The location server may update the measurement criteria in cases when there is a change on the service (integrity) requirements, and/or when the location server decides to change a positioning method.

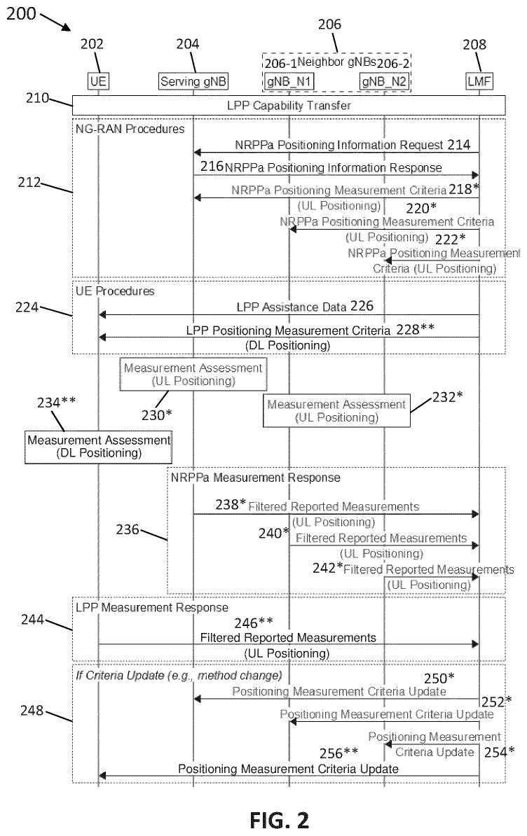

The described signaling process is summarized in FIG. 2, focusing on Embodiment 1. For the sake of compactness, both UL and DL positioning approaches are included in FIG. 2, where asterisks (* or **) are used to distinguish between new steps for UL positioning (*) and new steps for DL positioning (**). Also, a LMF is used in FIG. 2 (as well as in subsequent figures) as an example of the location server.

Accordingly, FIG. 2 is an example diagram 200 depicting signaling associated with positioning measurement criteria, where (*) indicates UL positioning and (**) indicates DL positioning. As is shown by the example of FIG. 2, the signaling includes a UE 202, a serving gNB 204, a set of neighbor gNBs 206, including gNB_N1 206-1 and gNB_N2 206-2, and a LMF 208. The LPP capability transfer 210 interfaces with at least one of the UE 202, the serving gNB 204, the set of neighbor gNBs 206, and the LMF 208.

The signaling 200 includes NG-RAN procedures 212, which includes signaling 214, 216, 218*, 220*, and 222*. At 214, the LMF 208 provides a NRPPa positioning information request 214 to the serving gNB 204. At 216, the serving gNB 204 provides a NRPPa positioning information response to the LMF 208. At 218*, the LMF 208 provides NRPPa positioning measurement criteria associated with UL positioning to the serving gNB 204. At 220*, the LMF 208 provides NRPPa positioning measurement criteria associated with UL positioning to gNB_N1 206-1 of the set of neighbor gNBs 206. At 222*, the LMF 208 provides NRPPa positioning measurement criteria associated with UL positioning to the gNB_N2 206-2 of the set of neighbor gNBs 206.

The signaling 200 includes UE procedures 224, including items 226 and 228**. At 226, the LMF 208 provides LPP assistance data to the UE 202. At 228**, the LMF 208 provides LPP positioning measurement criteria associated with DL positioning to the UE 202.

At 230*, the Serving gNB 204 performs a measurement assessment associated with UL Positioning. At 232*, the gNB_N1 206-1 and the gNB_N2 206-2 of the set of neighbor gNBs 206 perform a measurement assessment associated with UL positioning. At 234**, the UE 202 performs a measurement assessment associated with DL positioning.

The signaling 200 includes a NRPPa measurement response 236, which includes items 238*, 240*, and 242*. At 238*, the serving gNB 204 provides filtered reported measurements associated with UL positioning to the LMF 208. At 240*, the gNB_N1 206-1 of the set of neighbor gNBs 206 provides filtered reported measurements associated with UL positioning to the LMF 208. At 242*, the gNB_N2 206-2 of the set of neighbor gNBs 206 provides filtered reported measurements associated with UL positioning to the LMF 208.

The signaling 200 includes a LPP measurement response 244, including item 246**. At 246**, the UE 202 provides filtered reported measurements associated with UL positioning to the LMF 208.

In some examples, the signaling 200 also includes the UE 202, or one or more gNBs (the serving gNB 204 and/or the set of neighbor gNBs 206 including gNB_N1 206-1 and gNB-N2 206-2), or a transmission and/or reception point, providing an indication of a determined measurement reporting mode to the LMF 208, or to a location server or some other entity.

The signaling 200 also provides mechanisms 248 should there be an update to one or more criteria, such as a method change, which mechanisms include items 250*, 252*, 254*, and 256**. At 250*, the LMF 208 provides a positioning measurement criteria update (for example, associated with UL positioning) to the serving gNB 204. At 252*, the LMF 208 provides a positioning measurement criteria update (for example, associated with UL positioning) to the gNB_N1 206-1 of the set of neighbor gNBs 206. At 254*, the LMF 208 provides a positioning measurement criteria update (for example, associated with UL positioning) to the gNB_N2 206-2 of the set of neighbor gNBs 206. At 256**, the LMF 208 provides a positioning measurement criteria update (for example, associated with DL positioning) to the UE 202.

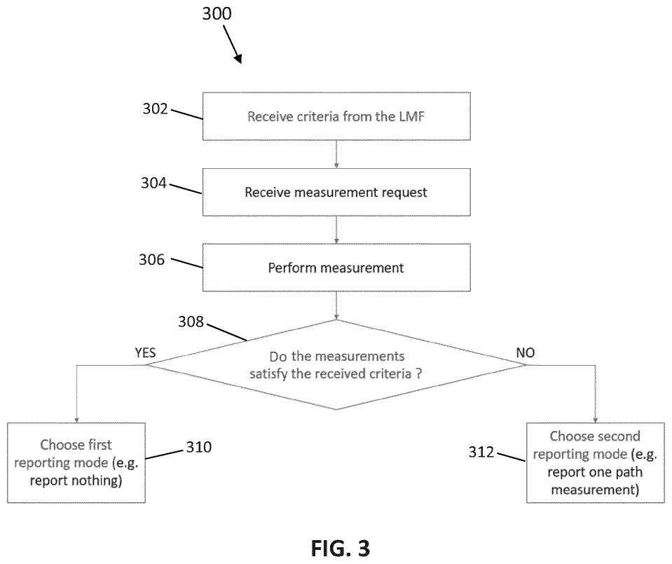

FIG. 3 shows exemplary logic diagrams (collectively 300) of a UE/gNB in Embodiment 1, which first receives criteria set by the LMF, and determines its own measurement reporting mode based on whether the measurement(s) were obtained in the conditions satisfying the received criteria.

At 302, the UE or gNB receives criteria from the LMF. At 304, the UE or gNB receives a measurement request. At 306, the UE or gNB performs one or more measurements. At 308, the UE or gNB determines whether the measurements satisfy the received criteria, or whether the measurements were obtained in conditions satisfying the received criteria. In response to a positive determination (for example, “YES”) at 308, the method proceeds to 310. In response to a negative determination (for example, “NO”) at 308, the method proceeds to 312. At 310, the UE or gNB chooses a first reporting mode (for example, report nothing). At 312, the UE or gNB chooses a second reporting mode (for example, report one path measurement). In some examples, the UE or gNB (or transmission and/or reception point) provides an indication of the determined measurement reporting mode (first reporting mode or second reporting mode) to the LMF (or to a location server or some other entity).

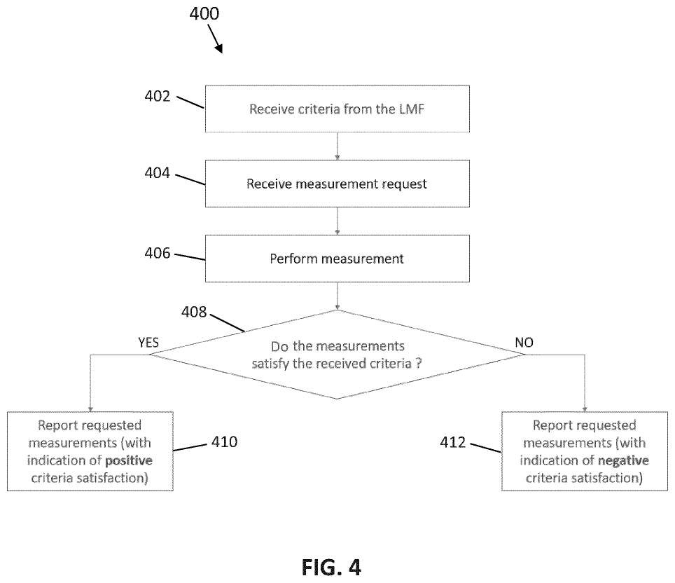

FIG. 4 shows exemplary logic diagrams (collectively 400) of a UE/gNB in Embodiment 2, which first receives criteria set by the LMF, and determines the indicator to be included in the report, based on whether the measurement was obtained in the conditions satisfying the received criteria.

At 402, the UE or gNB receives criteria from the LMF. At 404, the UE or gNB receives a measurement request. At 406, the UE or gNB performs one or more measurements. At 408, the UE or gNB determines whether the measurements satisfy the received criteria, or whether the measurements were obtained in conditions satisfying the received criteria. In response to a positive determination (for example, “YES”) at 408, the method proceeds to 410. In response to a negative determination (for example, “NO”) at 408, the method proceeds to 412. At 410, the UE or gNB reports the requested measurements with an indication of positive criteria satisfaction. At 412, the UE or gNB reports the requested measurements with an indication of negative criteria satisfaction.

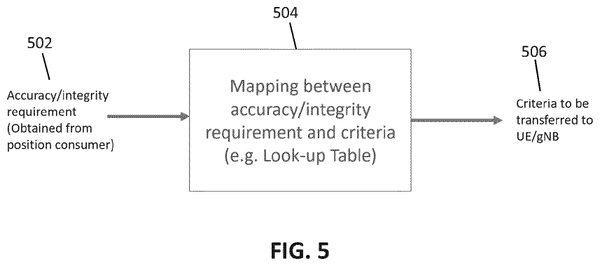

FIG. 5 shows a functional block 504 that can be implemented at the LMF to determine the criteria that should be transferred to UE/gNB based on accuracy/integrity requirements. As aforementioned, the LMF may determine this based on the accuracy and/or integrity requirement of the consumer (e.g. application) (see 502), and the LMF could have built-in a functional entity 504 that performs a mapping between the accuracy/integrity requirement 502 and criteria 506 that the propagation environment should meet (for example, the mapping may be implemented via a look-up table or a pre-defined rule). Note that this is an implementation issue of the LMF.

There are several advantages and technical effects of the examples described herein, including reporting overhead, avoidance of using inappropriate measurements, and integrity protection.

Reporting overhead: The described method offers a flexible and scalable framework where the measurement information is reported when it is obtained under a favorable condition useful for accurate/reliable position estimation, so it avoids some unnecessary reporting that may be useless, or even harmful, to the estimation at the LMF.

Avoidance of using inappropriate measurements: As discussed above, the LMF may filter out some inappropriate measurements by itself based on e.g. smart algorithms. However, this is still challenging especially when the information reported by UE/gNB is rather limited. With the described framework, the LMF can at least ensure some of the collected measurements are obtained under more desirable conditions.

Integrity Protection: Since the LMF can directly interact with the consumer about its requirement on accuracy, reliability, and/or integrity, it can identify the quality of measurements it needs. By setting the quality as criteria for the gNB/UE to select the reporting mode, the measurements collected by the LMF can sometimes provide it good measurement to achieve a specified integrity performance.

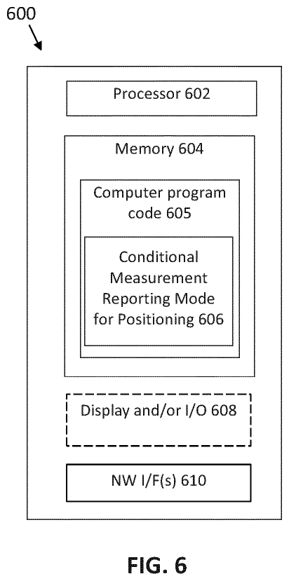

FIG. 6 is another example apparatus 600, which may be implemented in hardware, configured to implement a conditional measurement reporting mode for positioning based on the examples described herein. The apparatus 600 comprises a processor 602, at least one non-transitory memory 604 including computer program code 605, wherein the at least one memory 604 and the computer program code 605 are configured to, with the at least one processor 602, cause the apparatus 600 to implement a conditional measurement reporting mode for positioning 606 based on the examples described herein. The apparatus 600 optionally includes a display 608 that may be used to display aspects of the apparatus 600 or to provide input and output (I/O). The apparatus 600 also includes one or more network (NW) interfaces (I/F(s)) 610. The NW I/F(s) 610 may be wired and/or wireless and communicate over the Internet/other network(s) via any communication technique. The NW I/F(s) 610 may comprise one or more transmitters and one or more receivers. The apparatus 600 may be a UE, a gNB, an LMF or any other suitable device for implementing a conditional measurement reporting mode for positioning.

It should also be appreciated, with respect to FIG. 1, that any or both of module 140-1 and module 140-2 of UE 110 may provide functionality to support the implementation of the methods described herein for a conditional measurement reporting mode for positioning. In some examples, the functionality for the conditional measurement reporting mode for positioning may also be supported/implemented by module 150-1 and/or module 150-2 of RAN node 170, and/or computer program code 173 of network element 190, for example in combination with UE 110 (e.g., module 140-1 and/or module 140-2 of UE 110).

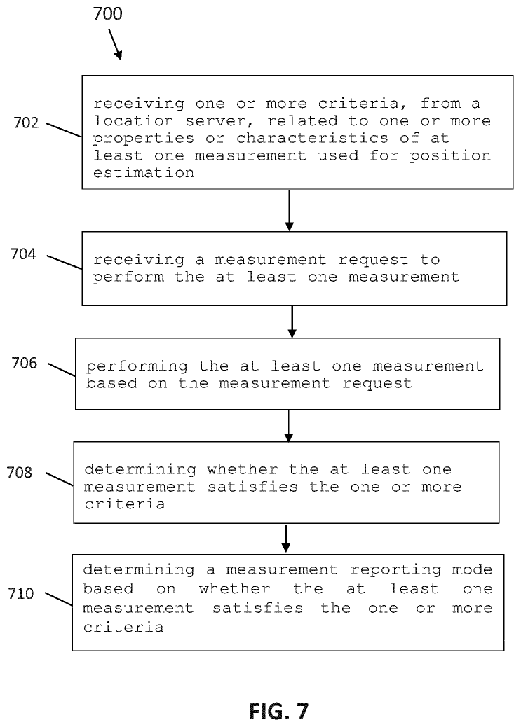

FIG. 7 is an example method 700 for implementation of a conditional measurement reporting mode for positioning. The method 700 may be implemented by a targeted device such as a UE or gNB. At 702, the method includes receiving one or more criteria, from a location server, related to one or more properties or characteristics of at least one measurement used for position estimation. At 704, the method includes receiving a measurement request to perform the at least one measurement. At 706, the method includes performing the at least one measurement based on the measurement request. At 708, the method includes determining whether the at least one measurement satisfies the one or more criteria. At 710, the method includes determining a measurement reporting mode based on whether the at least one measurement satisfies the one or more criteria.

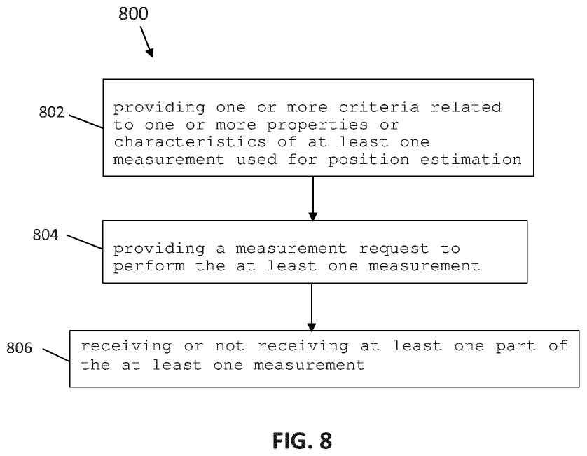

FIG. 8 is an example method 800 for implementation of a conditional measurement reporting mode for positioning. The method 800 may be implemented by a location manage server or location management function. At 802, the method includes providing one or more criteria related to one or more properties or characteristics of at least one measurement used for position estimation. At 804, the method includes providing a measurement request to perform the at least one measurement. At 806, the method includes receiving or not receiving at least one part of the at least one measurement.

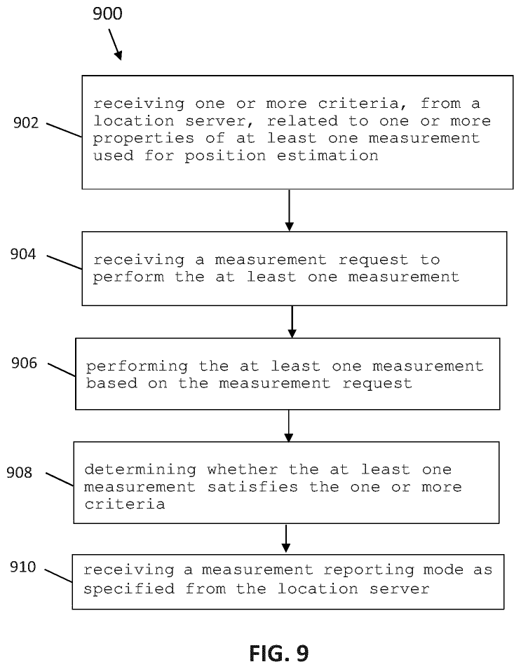

FIG. 9 is another example method 900 for implementation of a conditional measurement reporting mode for positioning. At 902, the method includes receiving one or more criteria, from a location server, related to one or more properties of at least one measurement used for position estimation. At 904, the method includes receiving a measurement request to perform the at least one measurement. At 906, the method includes performing the at least one measurement based on the measurement request. At 908, the method includes determining whether the at least one measurement satisfies the one or more criteria. At 910, the method includes receiving a measurement reporting mode as specified from the location server.

An example method includes receiving one or more criteria, from a location server, related to one or more properties of at least one measurement used for position estimation; receiving a measurement request to perform the at least one measurement; performing the at least one measurement based on the measurement request; determining whether the at least one measurement satisfies the one or more criteria; and determining a measurement reporting mode based on whether the at least one measurement satisfies the one or more criteria.

The method may further include receiving the measurement reporting mode as specified from the location server; reporting the at least one measurement based on the measurement reporting mode; and providing an indication of whether the at least one measurement was performed in conditions satisfying the one or more criteria.

The method may further include providing an indication of whether the one or more properties of the at least one measurement satisfy the one or more received criteria.

The method may further include reporting based on the determined measurement reporting mode.

The method may further include wherein the reporting comprises not reporting at least one part of the at least one measurement.

The method may further include wherein the reporting comprises reporting the at least one measurement with different levels of details.

The method may further include providing an indication of the determined measurement reporting mode to the location server or some other entity.

The method may be performed by either a user equipment, a radio node, or a transmission and/or reception point.

The method may further include wherein when a node to conduct the at least one measurement is a network node, the one or more criteria are received via a positioning protocol.

The method may further include wherein the network node is a gNB, a transmission and/or reception point, or a radio measurement node.

The method may further include wherein when a node to conduct the at least one measurement is a user equipment (UE), the one or more criteria are received via a positioning protocol.

The method may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The method may further include wherein the one or more criteria is related to at least one of: a presence of at least one line of sight path; a strength associated to the at least one line of sight path; a number of measured paths; an observed path delay; a capability of the device receiving the one or more criteria; or whether at least one item of evidence suggesting uncertainty of the quality of the at least one measurement is identified.

The method may further include wherein if the one or more criteria is related to evidence suggesting uncertainty of the quality of the at least one measurement, the evidence comprises one or more of noise peak, interference, or an authentication issue.

The method may further include receiving an update of the one or more criteria from the location server.

The method may further include wherein the one or more criteria varies depending on a positioning method to be applied.

The method may further include wherein the at least one measurement is related to a sound reference signal or a positioning reference signal.

The method may further include wherein determining whether the at least one measurement satisfies the one or more criteria comprises determining whether the at least one measurement was performed in conditions satisfying the one or more criteria.

An example method includes providing one or more criteria related to one or more properties of at least one measurement used for position estimation; providing a measurement request to perform the at least one measurement; and receiving or not receiving at least one part of the at least one measurement.

The method may further include providing a measurement reporting mode; and receiving an indication of whether the at least one measurement was performed in conditions satisfying the one or more criteria.

The method may further include receiving an indication of whether the one or more properties of the at least one measurement satisfy the one or more criteria.

The method may further include wherein the indication of whether the one or more properties of the at least one measurement satisfies the one or more criteria comprises an indication of whether the at least one measurement was performed in conditions satisfying the one or more criteria.

The method may further include receiving an indication of a determined measurement reporting mode.

The method may further include receiving the at least one measurement with different levels of details.

The method may further include determining the one or more criteria by implementing a mapping between an accuracy or integrity requirement obtained from a position consumer, and the one or more criteria.

The method may further include wherein the mapping is implemented via a look-up table or a pre-defined rule.

The method may be performed by a location server.

The method may further include wherein when a node to conduct the at least one measurement is a network node, the one or more criteria are provided via a positioning protocol.

The method may further include wherein the network node is a gNB, a transmission and/or reception point, or a radio measurement node.

The method may further include wherein when a node to conduct the at least one measurement is a user equipment (UE), the one or more criteria are provided via a positioning protocol.

The method may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The method may further include wherein the one or more criteria is related to at least one of: a presence of at least one line of sight; a strength associated to the at least one line of sight path; a number of measured paths; an observed path delay; a capability of the device receiving the one or more criteria; or whether at least one item of evidence suggesting uncertainty of the quality of the at least one measurement is identified.

The method may further include wherein if the one or more criteria is related to evidence suggesting uncertainty of the quality of the at least one measurement, the evidence comprises one or more of noise peak, interference, or an authentication issue.

The method may further include providing an update of the one or more criteria.

The method may further include wherein the one or more criteria varies depending on a positioning method to be applied.

The method may further include wherein the at least one measurement is related to a sound reference signal or a positioning reference signal.

An example apparatus includes at least one processor; and at least one non-transitory memory including computer program code; wherein the at least one memory and the computer program code are configured to, with the at least one processor, cause the apparatus at least to perform: receive one or more criteria, from a location server, related to one or more properties of at least one measurement used for position estimation; receive a measurement request to perform the at least one measurement; perform the at least one measurement based on the measurement request; determine whether the at least one measurement satisfies the one or more criteria; and determine a measurement reporting mode based on whether the at least one measurement satisfies the one or more criteria.

The apparatus may further include wherein the at least one memory and the computer program code are further configured to, with the at least one processor, cause the apparatus at least to perform: receive the measurement reporting mode as specified from the location server; report the at least one measurement based on the measurement reporting mode; and provide an indication of whether the at least one measurement was performed in conditions satisfying the one or more criteria.

The apparatus may further include wherein the at least one memory and the computer program code are further configured to, with the at least one processor, cause the apparatus at least to perform: provide an indication of whether the one or more properties of the at least one measurement satisfy the one or more received criteria.

The apparatus may further include wherein the at least one memory and the computer program code are further configured to, with the at least one processor, cause the apparatus at least to perform: report based on the determined measurement reporting mode.

The apparatus may further include wherein the reporting comprises not reporting at least one part of the at least one measurement.

The apparatus may further include wherein the reporting comprises reporting the at least one measurement with different levels of details.

The apparatus may further include wherein the at least one memory and the computer program code are further configured to, with the at least one processor, cause the apparatus at least to perform: provide an indication of the determined measurement reporting mode to the location server or some other entity.

The apparatus may further include wherein the apparatus is either a user equipment, a radio node, or a transmission and/or reception point.

The apparatus may further include wherein when a node to conduct the at least one measurement is a network node, the one or more criteria are received via a positioning protocol.

The apparatus may further include wherein the network node is a gNB, a transmission and/or reception point, or a radio measurement node.

The apparatus may further include wherein when a node to conduct the at least one measurement is a user equipment (UE), the one or more criteria are received via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight path; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include wherein the at least one memory and the computer program code are further configured to, with the at least one processor, cause the apparatus at least to perform: receive an update of the one or more criteria from the location server.

The apparatus may further include wherein the one or more criteria varies depending on a positioning method to be applied.

The apparatus may further include wherein the at least one measurement is related to a sound reference signal or a positioning reference signal.

The apparatus may further include wherein the determining whether the at least one measurement satisfies the one or more criteria comprises determining whether the at least one measurement was performed in conditions satisfying the one or more criteria.

An example apparatus includes at least one processor; and at least one non-transitory memory including computer program code; wherein the at least one memory and the computer program code are configured to, with the at least one processor, cause the apparatus at least to perform: provide one or more criteria related to one or more properties of at least one measurement used for position estimation; provide a measurement request to perform the at least one measurement; and receive or not receive at least one part of the at least one measurement.

The apparatus may further include wherein the at least one memory and the computer program code are further configured to, with the at least one processor, cause the apparatus at least to perform: provide a measurement reporting mode; and receive an indication of whether the at least one measurement was performed in conditions satisfying the one or more criteria.

The apparatus may further include wherein the at least one memory and the computer program code are further configured to, with the at least one processor, cause the apparatus at least to perform: receive an indication of whether the one or more properties of the at least one measurement satisfy the one or more criteria.

The apparatus may further include wherein the indication of whether the one or more properties of the at least one measurement satisfies the one or more criteria comprises an indication of whether the at least one measurement was performed in conditions satisfying the one or more criteria.

The apparatus may further include wherein the at least one memory and the computer program code are further configured to, with the at least one processor, cause the apparatus at least to perform: receive an indication of a determined measurement reporting mode.

The apparatus may further include wherein the at least one memory and the computer program code are further configured to, with the at least one processor, cause the apparatus at least to perform: receive the at least one measurement with different levels of details.

The apparatus may further include wherein the at least one memory and the computer program code are further configured to, with the at least one processor, cause the apparatus at least to perform: determine the one or more criteria by implementing a mapping between an accuracy or integrity requirement obtained from a position consumer, and the one or more criteria.

The apparatus may further include wherein the mapping is implemented via a look-up table or a pre-defined rule.

The apparatus may further include wherein the apparatus is a location server.

The apparatus may further include wherein when a node to conduct the at least one measurement is a network node, the one or more criteria are provided via a positioning protocol.

The apparatus may further include wherein the network node is a gNB, a transmission and/or reception point, or a radio measurement node.

The apparatus may further include wherein when a node to conduct the at least one measurement is a user equipment (UE), the one or more criteria are provided via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include wherein the at least one memory and the computer program code are further configured to, with the at least one processor, cause the apparatus at least to perform: provide an update of the one or more criteria.

The apparatus may further include wherein the one or more criteria varies depending on a positioning method to be applied.

The apparatus may further include wherein the at least one measurement is related to a sound reference signal or a positioning reference signal.

An example non-transitory program storage device readable by a machine, tangibly embodying a program of instructions executable by the machine for performing operations may be provided, the operations comprising: receiving one or more criteria, from a location server, related to one or more properties of at least one measurement used for position estimation; receiving a measurement request to perform the at least one measurement; performing the at least one measurement based on the measurement request; determining whether the at least one measurement satisfies the one or more criteria; and determining a measurement reporting mode based on whether the at least one measurement satisfies the one or more criteria.

The non-transitory program storage device may further include wherein the operations further comprise: receiving the measurement reporting mode as specified from the location server; reporting the at least one measurement based on the measurement reporting mode; and providing an indication of whether the at least one measurement was performed in conditions satisfying the one or more criteria.

The non-transitory program storage device may further include wherein the operations further comprise: providing an indication of whether the one or more properties of the at least one measurement satisfy the one or more received criteria.

The non-transitory program storage device may further include wherein the operations further comprise: reporting based on the determined measurement reporting mode.

The non-transitory program storage device may further include wherein the reporting comprises not reporting at least one part of the at least one measurement.

The non-transitory program storage device may further include wherein the reporting comprises reporting the at least one measurement with different levels of details.

The non-transitory program storage device may further include wherein the operations further comprise: providing an indication of the determined measurement reporting mode to the location server or some other entity.

The non-transitory program storage device may further include wherein the operations are performed by either a user equipment, a radio node, or a transmission and/or reception point.

The non-transitory program storage device may further include wherein when a node to conduct the at least one measurement is a network node, the one or more criteria are received via a positioning protocol.

The non-transitory program storage device may further include wherein the network node is a gNB, a transmission and/or reception point, or a radio measurement node.

The non-transitory program storage device may further include wherein when a node to conduct the at least one measurement is a user equipment (UE), the one or more criteria are received via a positioning protocol.

The non-transitory program storage device may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The non-transitory program storage device may further include wherein the one or more criteria is related to at least one of: a presence of at least one line of sight path; a strength associated to the at least one line of sight path; a number of measured paths; an observed path delay; a capability of the device receiving the one or more criteria; or whether at least one item of evidence suggesting uncertainty of the quality of the at least one measurement is identified.

The non-transitory program storage device may further include wherein if the one or more criteria is related to evidence suggesting uncertainty of the quality of the at least one measurement, the evidence comprises one or more of noise peak, interference, or an authentication issue.

The non-transitory program storage device may further include wherein the operations further comprise receiving an update of the one or more criteria from the location server.

The non-transitory program storage device may further include wherein the one or more criteria varies depending on a positioning method to be applied.

The non-transitory program storage device may further include wherein the at least one measurement is related to a sound reference signal or a positioning reference signal.

The non-transitory program storage device may further include wherein determining whether the at least one measurement satisfies the one or more criteria comprises determining whether the at least one measurement was performed in conditions satisfying the one or more criteria.

An example non-transitory program storage device readable by a machine, tangibly embodying a program of instructions executable by the machine for performing operations may be provided, the operations comprising: providing one or more criteria related to one or more properties of at least one measurement used for position estimation; providing a measurement request to perform the at least one measurement; and receiving or not receiving at least one part of the at least one measurement.

The non-transitory program storage device may further include wherein the operations further comprise: providing a measurement reporting mode; and receiving an indication of whether the at least one measurement was performed in conditions satisfying the one or more criteria.

The non-transitory program storage device may further include wherein the operations further comprise: receiving an indication of whether the one or more properties of the at least one measurement satisfy the one or more criteria.

The non-transitory program storage device may further include wherein the indication of whether the one or more properties of the at least one measurement satisfies the one or more criteria comprises an indication of whether the at least one measurement was performed in conditions satisfying the one or more criteria.

The non-transitory program storage device may further include wherein the operations further comprise: receiving an indication of a determined measurement reporting mode.

The non-transitory program storage device may further include wherein the operations further comprise: receiving the at least one measurement with different levels of details.

The non-transitory program storage device may further include wherein the operations further comprise: determining the one or more criteria by implementing a mapping between an accuracy or integrity requirement obtained from a position consumer, and the one or more criteria.

The non-transitory program storage device may further include wherein the mapping is implemented via a look-up table or a pre-defined rule.

The non-transitory program storage device may further include wherein the operations are performed by a location server.

The non-transitory program storage device may further include wherein when a node to conduct the at least one measurement is a network node, the one or more criteria are provided via a positioning protocol.

The non-transitory program storage device may further include wherein the network node is a gNB, a transmission and/or reception point, or a radio measurement node.

The non-transitory program storage device may further include wherein when a node to conduct the at least one measurement is a user equipment (UE), the one or more criteria are provided via a positioning protocol.

The non-transitory program storage device may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The non-transitory program storage device may further include wherein the one or more criteria is related to at least one of: a presence of at least one line of sight; a strength associated to the at least one line of sight path; a number of measured paths; an observed path delay; a capability of the device receiving the one or more criteria; or whether at least one item of evidence suggesting uncertainty of the quality of the at least one measurement is identified.

The non-transitory program storage device may further include wherein if the one or more criteria is related to evidence suggesting uncertainty of the quality of the at least one measurement, the evidence comprises one or more of noise peak, interference, or an authentication issue.

The non-transitory program storage device may further include wherein the operations further comprise: providing an update of the one or more criteria.

The non-transitory program storage device may further include wherein the one or more criteria varies depending on a positioning method to be applied.

The non-transitory program storage device may further include wherein the at least one measurement is related to a sound reference signal or a positioning reference signal.

An example apparatus includes means for receiving one or more criteria, from a location server, related to one or more properties of at least one measurement used for position estimation; means for receiving a measurement request to perform the at least one measurement; means for performing the at least one measurement based on the measurement request; means for determining whether the at least one measurement satisfies the one or more criteria; and means for determining a measurement reporting mode based on whether the at least one measurement satisfies the one or more criteria.

The apparatus may further include means for receiving the measurement reporting mode as specified from the location server; means for reporting the at least one measurement based on the measurement reporting mode; and means for providing an indication of whether the at least one measurement was performed in conditions satisfying the one or more criteria.

The apparatus may further include means for providing an indication of whether the one or more properties of the at least one measurement satisfy the one or more received criteria.

The apparatus may further include means for reporting based on the determined measurement reporting mode.

The apparatus may further include wherein the reporting comprises not reporting at least one part of the at least one measurement.

The apparatus may further include wherein the reporting comprises reporting the at least one measurement with different levels of details.

The apparatus may further include means for providing an indication of the determined measurement reporting mode to the location server or some other entity.

The apparatus may further include wherein the apparatus is either a user equipment, a radio node, or a transmission and/or reception point.

The apparatus may further include wherein when a node to conduct the at least one measurement is a network node, the one or more criteria are received via a positioning protocol.

The apparatus may further include wherein the network node is a gNB, a transmission and/or reception point, or a radio measurement node.

The apparatus may further include wherein when a node to conduct the at least one measurement is a user equipment (UE), the one or more criteria are received via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight path; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include means for receiving an update of the one or more criteria from the location server.

The apparatus may further include wherein the one or more criteria varies depending on a positioning method to be applied.

The apparatus may further include wherein the at least one measurement is related to a sound reference signal or a positioning reference signal.

The apparatus may further include wherein determining whether the at least one measurement satisfies the one or more criteria comprises determining whether the at least one measurement was performed in conditions satisfying the one or more criteria.

An example apparatus includes means for providing one or more criteria related to one or more properties of at least one measurement used for position estimation; means for providing a measurement request to perform the at least one measurement; and means for receiving or not receiving at least one part of the at least one measurement.

The apparatus may further include means for providing a measurement reporting mode; and means for receiving an indication of whether the at least one measurement was performed in conditions satisfying the one or more criteria.

The apparatus may further include means for receiving an indication of whether the one or more properties of the at least one measurement satisfy the one or more criteria.

The apparatus may further include wherein the indication of whether the one or more properties of the at least one measurement satisfies the one or more criteria comprises an indication of whether the at least one measurement was performed in conditions satisfying the one or more criteria.

The apparatus may further include means for receiving an indication of a determined measurement reporting mode.

The apparatus may further include means for receiving the at least one measurement with different levels of details.

The apparatus may further include means for determining the one or more criteria by implementing a mapping between an accuracy or integrity requirement obtained from a position consumer, and the one or more criteria.

The apparatus may further include wherein the mapping is implemented via a look-up table or a pre-defined rule.

The apparatus may further include wherein the apparatus is a location server.

The apparatus may further include wherein when a node to conduct the at least one measurement is a network node, the one or more criteria are provided via a positioning protocol.

The apparatus may further include wherein the network node is a gNB, a transmission and/or reception point, or a radio measurement node.

The apparatus may further include wherein when a node to conduct the at least one measurement is a user equipment (UE), the one or more criteria are provided via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include means for providing an update of the one or more criteria.

The apparatus may further include wherein the one or more criteria varies depending on a positioning method to be applied.

The apparatus may further include wherein the at least one measurement is related to a sound reference signal or a positioning reference signal.

An example apparatus includes processing circuitry; and memory circuitry including computer program code, the memory circuitry and the computer program code configured to, with the processing circuitry, enable the apparatus to: receive one or more criteria, from a location server, related to one or more properties of at least one measurement used for position estimation; receive a measurement request to perform the at least one measurement; perform the at least one measurement based on the measurement request; determine whether the at least one measurement satisfies the one or more criteria; and determine a measurement reporting mode based on whether the at least one measurement satisfies the one or more criteria.

The apparatus may further include wherein the memory circuitry and the computer program code are further configured to, with the processing circuitry, enable the apparatus to: receive the measurement reporting mode as specified from the location server; report the at least one measurement based on the measurement reporting mode; and provide an indication of whether the at least one measurement was performed in conditions satisfying the one or more criteria. The apparatus may further include wherein the memory circuitry and the computer program code are further configured to, with the processing circuitry, enable the apparatus to: provide an indication of whether the one or more properties of the at least one measurement satisfy the one or more received criteria.

The apparatus may further include wherein the memory circuitry and the computer program code are further configured to, with the processing circuitry, enable the apparatus to: report based on the determined measurement reporting mode. The apparatus may further include wherein the reporting comprises not reporting at least one part of the at least one measurement.

The apparatus may further include wherein the reporting comprises reporting the at least one measurement with different levels of details. The apparatus may further include wherein the memory circuitry and the computer program code are further configured to, with the processing circuitry, enable the apparatus to: provide an indication of the determined measurement reporting mode to the location server or some other entity.

The apparatus may further include wherein the apparatus is either a user equipment, a radio node, or a transmission and/or reception point. The apparatus may further include wherein when a node to conduct the at least one measurement is a network node, the one or more criteria are received via a positioning protocol.

The apparatus may further include wherein the network node is a gNB, a transmission and/or reception point, or a radio measurement node. The apparatus may further include wherein when a node to conduct the at least one measurement is a user equipment (UE), the one or more criteria are received via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight path; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include wherein the memory circuitry and the computer program code are further configured to, with the processing circuitry, enable the apparatus to: receive an update of the one or more criteria from the location server.

The apparatus may further include wherein the one or more criteria varies depending on a positioning method to be applied. The apparatus may further include wherein the at least one measurement is related to a sound reference signal or a positioning reference signal. The apparatus may further include wherein the determining whether the at least one measurement satisfies the one or more criteria comprises determining whether the at least one measurement was performed in conditions satisfying the one or more criteria.

An example apparatus includes processing circuitry; and memory circuitry including computer program code, the memory circuitry and the computer program code configured to, with the processing circuitry, enable the apparatus to: provide one or more criteria related to one or more properties of at least one measurement used for position estimation; provide a measurement request to perform the at least one measurement; and receive or not receive at least one part of the at least one measurement.

The apparatus may further include wherein the memory circuitry and the computer program code are further configured to, with the processing circuitry, enable the apparatus to: provide a measurement reporting mode; and receive an indication of whether the at least one measurement was performed in conditions satisfying the one or more criteria. The apparatus may further include wherein the memory circuitry and the computer program code are further configured to, with the processing circuitry, enable the apparatus to: receive an indication of whether the one or more properties of the at least one measurement satisfy the one or more criteria.

The apparatus may further include wherein the indication of whether the one or more properties of the at least one measurement satisfies the one or more criteria comprises an indication of whether the at least one measurement was performed in conditions satisfying the one or more criteria. The apparatus may further include wherein the memory circuitry and the computer program code are further configured to, with the processing circuitry, enable the apparatus to: receive an indication of a determined measurement reporting mode.

The apparatus may further include wherein the memory circuitry and the computer program code are further configured to, with the processing circuitry, enable the apparatus to: receive the at least one measurement with different levels of details.

The apparatus may further include wherein the memory circuitry and the computer program code are further configured to, with the processing circuitry, enable the apparatus to: determine the one or more criteria by implementing a mapping between an accuracy or integrity requirement obtained from a position consumer, and the one or more criteria.

The apparatus may further include wherein the mapping is implemented via a look-up table or a pre-defined rule.

The apparatus may further include wherein the apparatus is a location server.

The apparatus may further include wherein when a node to conduct the at least one measurement is a network node, the one or more criteria are provided via a positioning protocol.

The apparatus may further include wherein the network node is a gNB, a transmission and/or reception point, or a radio measurement node.

The apparatus may further include wherein when a node to conduct the at least one measurement is a user equipment (UE), the one or more criteria are provided via a positioning protocol.

The apparatus may further include wherein the measurement reporting mode comprises either: no reporting of the at least one measurement; reporting the at least one measurement related to one path; reporting the at least one measurement related to multiple paths; reporting the at least one measurement related to a strongest of the multiple paths; reporting the at least one measurement related to a shortest of the multiple paths; or reporting the at least one measurement related to a number of paths that a device is capable of measuring or reporting.

The apparatus may further include wherein the one or more criteria is related to at least one of: a presence of at least one line of sight; a strength associated to the at least one line of sight path; a number of measured paths; an observed path delay; a capability of the device receiving the one or more criteria; or whether at least one item of evidence suggesting uncertainty of the quality of the at least one measurement is identified.

The apparatus may further include wherein if the one or more criteria is related to evidence suggesting uncertainty of the quality of the at least one measurement, the evidence comprises one or more of noise peak, interference, or an authentication issue.

The apparatus may further include wherein the memory circuitry and the computer program code are further configured to, with the processing circuitry, enable the apparatus to: provide an update of the one or more criteria.

The apparatus may further include wherein the one or more criteria varies depending on a positioning method to be applied.

The apparatus may further include wherein the at least one measurement is related to a sound reference signal or a positioning reference signal.

An example network includes at least one apparatus described herein, including the apparatus depicted in FIG. 6 and any of the apparatuses depicted in FIG. 1.

An example network includes at least one non-transitory program storage device as described herein, including one to execute the computer program code 606 shown in FIG. 6, and/or modules of FIG. 1, including one or more of module 140-1, module 140-2, module 150-1, module 150-2, or computer program code 173.

An example method includes receiving one or more criteria, from a location server, related to one or more properties of at least one measurement used for position estimation; receiving a measurement request to perform the at least one measurement; performing the at least one measurement based on the measurement request; determining whether the at least one measurement satisfies the one or more criteria; and receiving a measurement reporting mode as specified from the location server. The method may further include reporting the at least one measurement based on the measurement reporting mode; and providing an indication of whether the at least one measurement was performed in conditions satisfying the one or more criteria.

It should be understood that the foregoing description is merely illustrative. Various alternatives and modifications can be devised by those skilled in the art. For example, features recited in the various dependent claims could be combined with one another in any suitable combination(s). In addition, features from different embodiments described above could be selectively combined into a new embodiment. Accordingly, the description is intended to embrace such alternatives, modifications and variances which fall within the scope of the appended claims.

1-184. (canceled)

185. A method comprising:
receiving one or more criteria, from a location server, related to one or more properties of at least one measurement used for position estimation;
receiving a measurement request to perform the at least one measurement;
performing the at least one measurement based on the measurement request;
determining whether the at least one measurement satisfies the one or more criteria; and
determining a measurement reporting mode based on whether the at least one measurement satisfies the one or more criteria in the absence of the location server specifying a measurement reporting mode.

186. The method of claim 185, further comprising:
receiving the measurement reporting mode as specified from the location server;
reporting the at least one measurement based on the measurement reporting mode; and
providing an indication of whether the at least one measurement was performed in conditions satisfying the one or more criteria.

187. A method comprising:
providing one or more criteria related to one or more properties of at least one measurement used for position estimation;
providing a measurement request to perform the at least one measurement; and
receiving or not receiving at least one part of the at least one measurement.

188. The method of claim 187, further comprising:
providing a measurement reporting mode; and
receiving an indication of whether the at least one measurement was performed in conditions satisfying the one or more criteria.

189. The method of claim 187, further comprising receiving an indication of whether the one or more properties of the at least one measurement satisfy the one or more criteria.

190. The method of claim 188, wherein the indication of whether the one or more properties of the at least one measurement satisfies the one or more criteria comprises an indication of whether the at least one measurement was performed in conditions satisfying the one or more criteria.

191. The method of claim 187, performed by a location server.

192. The method of claim 187, wherein when a node to conduct the at least one measurement is a user equipment (UE), the one or more criteria are provided via a positioning protocol.

193. The method of claim 187, wherein the one or more criteria is related to at least one of:
a presence of at least one line of sight;
a strength associated to the at least one line of sight path;
a number of measured paths;
an observed path delay;
a capability of the device receiving the one or more criteria; or
whether at least one item of evidence suggesting uncertainty of the quality of the at least one measurement is identified.

194. The method of claim 187, wherein the at least one measurement is related to a sound reference signal or a positioning reference signal.

195. An apparatus comprising:
at least one processor; and
at least one non-transitory memory including computer program code;
wherein the at least one memory and the computer program code are configured to, with the at least one processor, cause the apparatus at least to perform:
receive one or more criteria, from a location server, related to one or more properties of at least one measurement used for position estimation;
receive a measurement request to perform the at least one measurement;
perform the at least one measurement based on the measurement request;
determine whether the at least one measurement satisfies the one or more criteria; and
determine a measurement reporting mode based on whether the at least one measurement satisfies the one or more criteria in the absence of the location server specifying a measurement reporting mode.

196. The apparatus of claim 195, wherein the at least one memory and the computer program code are further configured to, with the at least one processor, cause the apparatus at least to perform:
receive the measurement reporting mode as specified from the location server;
report the at least one measurement based on the measurement reporting mode; and
provide an indication of whether the at least one measurement was performed in conditions satisfying the one or more criteria.

197. An apparatus comprising:
at least one processor; and
at least one non-transitory memory including computer program code;
wherein the at least one memory and the computer program code are configured to, with the at least one processor, cause the apparatus at least to perform:
provide one or more criteria related to one or more properties of at least one measurement used for position estimation;
provide a measurement request to perform the at least one measurement; and
receive or not receive at least one part of the at least one measurement.

198. The apparatus of claim 197, wherein the at least one memory and the computer program code are further configured to, with the at least one processor, cause the apparatus at least to perform:
provide a measurement reporting mode; and
receive an indication of whether the at least one measurement was performed in conditions satisfying the one or more criteria.

199. A method comprising:
receiving one or more criteria, from a location server, related to one or more properties of at least one measurement used for position estimation;
receiving a measurement request to perform the at least one measurement;
performing the at least one measurement based on the measurement request;
determining whether the at least one measurement satisfies the one or more criteria; and
receiving a measurement reporting mode as specified from the location server.
